(19) United States
(12) Patent Application Publication
(10) Pub. No.: US 2016/0355431 A1
(43) Pub. Date: Dec. 8, 2016

(54) GLASS FOR CHEMICAL STRENGTHENING AND CHEMICALLY STRENGTHENED GLASS

(71) Applicant: ASAHI GLASS COMPANY, LIMITED, Chiyoda-ku (JP)

(72) Inventors: Shusaku Akiba, Tokyo (JP); Akio Koike, Tokyo (JP); Junichiro Kase, Tokyo (JP); Shuji Yamazaki, Tokyo (JP)

(73) Assignee: ASAHI GLASS COMPANY, LIMITED, Chiyoda-ku (JP)

(21) Appl. No.: 15/179,273

(22) Filed: Jun. 10, 2016

Related U.S. Application Data
(63) Continuation of application No. PCT/JP2014/082994, filed on Dec. 12, 2014.

(30) Foreign Application Priority Data
Dec. 13, 2013 (JP) 2013-258116
Feb. 7, 2014 (JP) 2014-022850

(51) Int. Cl. C03C 3/087; C03C 21/00

(52) U.S. Cl. CPC C03C 3/087; C03C 21/002

(57) ABSTRACT

A chemically strengthened glass contains, as expressed by mass percentage based on oxides, 60% to 75% of SiO₂, 3% to 9% of Al₂O₃, 2% to 10% of MgO, 3% to 10% of CaO, 10% to 18% of Na₂O, at most 4% of K₂O, 0% to 3% of ZrO₂, 0% to 0.3% of TiO₂, and 0.02% to 0.4% of SO₃. It has a temperature T₂ at which a viscosity of a glass melt is 100 dPa·sec of 1530° C. or lower. In a chemically strengthened main surface thereof, it has a depth of a compressive stress layer of 8 μm or more and a surface compressive stress of 500 MPa or more.

### TECHNICAL FIELD

The present invention relates to a glass for chemical strengthening and a chemically strengthened glass.

### BACKGROUND ART

Display devices equipped with, for example, a display means such as a liquid-crystal member, an LED member or the like are widely used, for example, as small-sized and/or portable display devices such as electronic notebooks, notebook-type personal computers, tablet PCs, smartphones, etc. In such display devices, a cover glass is provided on the surface thereof for protecting the display devices.

There is a relatively high possibility that display devices, especially portable display devices may be incautiously dropped down during use or transport thereof by users. Consequently, a cover glass is desired that has a high strength enough to prevent the cover glass from being broken even when display devices are dropped down.

Accordingly, for increasing the strength of a cover glass, it is considered to apply chemical strengthening treatment to the cover glass.

Given the situation, as a cover glass, there are two glass compositions of a soda lime glass and an aluminosilicate glass. A soda lime glass may not form a thick surface compressive stress layer by applying chemical strengthening treatment, as compared with an aluminosilicate glass. However, from the viewpoint of easiness in production and cost, a soda lime glass is selected in many cases as a glass for chemical strengthening (PTL 1, etc.).

### CITATION LIST

### Patent Literature

PTL 1: JP-A 2009-84076
PTL 2: WO2013/047676
PTL 3: JP-A 2013-71878
PTL 4: JP-A 2004-43295

### Non-Patent Literature

NPL 1: A. A. AHMED, Origin of Absorption Bands Observed in the Spectra of Silver Ion-Exchanged Soda-Lime-Silica Glass, Journal of the American Chemical Society, 1995.10, Vol. 78, No. 10, 2777-2784

### SUMMARY OF INVENTION

### Technical Problem

However, the glass of PTL 1 contains much Al₂O₃ of 9.2% or more in terms of % by mass, and the viscosity of the glass melt at a high temperature is high. Specifically, the temperature T₂ at which the viscosity of the glass melt is 100 dPa·sec and the temperature T₄ at which the viscosity of the glass melt is 10⁴ dPa·sec are high, and therefore, there is a problem in glass melting and forming in mass production of the glass according to a float process.

PTL 2 discloses one composition as an example. Specifically, it is a glass produced according to a float process, which contains, in terms of % by mass, SiO₂: 71.6%, Na₂O: 12.5%, K₂O: 1.3%, CaO: 8.5%, MgO: 3.6%, Al₂O₃: 2.1%, Fe₂O₃: 0.10%, and SO₃: 0.3%. The glass of PTL 2 contains a small amount, 2.1% of Al₂O₃, and in mass production thereof, tin penetration from the bottom surface thereof could not be sufficiently prevented, and there is another problem in that, if not subjected to two-stage chemical strengthening, the surface compression stress thereof could not be sufficiently enhanced.

PTL 3 discloses three compositions as examples. Specifically, they are glasses produced in a platinum crucible, including (1) a glass containing, in terms of % by mass, SiO₂: 57.0%, Al₂O₃: 12.5%, Na₂O: 14.0%, K₂O: 6.0%, MgO: 2.0%, ZrO₂: 3.5%, and TiO₂: 5.0%, (2) a glass containing, in terms of % by mass, SiO₂: 61.0%, Al₂O₃: 17.0%, B₂O₃: 0.5%, Na₂O: 13.5%, K₂O: 3.0%, MgO: 4.0%, CaO: 0.5%, and SnO: 0.5%, and (3) a glass containing, in terms of % by mass, SiO₂: 70.0%, Al₂O₃: 3.0%, B₂O₃: 5.0%, Na₂O: 14.0%, K₂O: 2.0%, MgO: 2.0%, and CaO: 4.0%. Here, in the glass (1) in PTL 3, especially the amount of TiO₂ is 5.0% and is extremely large, and there is thus a problem such that the glass may be yellowish. In the glass (2) in PTL 3, especially the amount of Al₂O₃ is 17.0% and is large, and there is thus a problem in glass melting and forming. In the glass (3) in PTL 3, especially the amount of B₂O₃ is 5.0% and is large, and since it is contained along with alkali components, there is a problem that the glass would remarkably corrode bricks.

PTL 4 discloses 19 compositions as examples. Though individual differences are omitted here, compositions where the content of K₂O is large and compositions where the content of Na₂O is small are disclosed therein. All the compositions are glasses produced in a platinum crucible, and do not contain SO₃ at all, and therefore have a problem in that they could not suppress bubble defects.

NPL 1 discloses compositions of a chemically strengthened glass. However, all the glass compositions do not contain SO₃ at all, and therefore have a problem in that they could not suppress bubble defects.

The present invention has been made in consideration of these problems, and an object of the present invention is to provide a glass having high scratch resistance and therefore having a high strength as a cover glass, which, in addition, enables to relatively lower the melting temperature in glass production.

### Solution to Problem

The present invention provides a chemically strengthened glass containing, as expressed by mass percentage based on oxides:

60% to 75% of SiO₂,

3% to 9% of Al₂O₃,

2% to 10% of MgO,

3% to 10% of CaO,

10% to 18% of Na₂O,

at most 4% of K₂O,

0% to 3% of ZrO₂,

0% to 0.3% of TiO₂, and

0.02% to 0.4% of SO₃;

having a temperature T₂ at which a viscosity of a glass melt is 100 dPa·sec of 1530° C. or lower; and

in a chemically strengthened main surface thereof, having a depth of a compressive stress layer of 8 μm or more and a surface compressive stress of 500 MPa or more.

Here, the chemically strengthened glass of the present invention may have a thickness falling within a range of 0.1 mm to 5 mm.

The chemically strengthened glass of the present invention may be chemically strengthened in all edge surfaces thereof.

In the chemically strengthened glass of the present invention, the depth of the compressive stress layer may be 25 μm or less.

The chemically strengthened glass of the present invention may be one produced according to a float process.

In the chemically strengthened glass of the present invention, an Sn component may exist in at least one surface of glass surfaces.

In addition, the present invention provides a glass

containing, as expressed by mass percentage based on oxides:

60% to 75% of SiO₂,

3% to 9% of Al₂O₃,

2% to 10% of MgO,

3% to 10% of CaO,

10% to 18% of Na₂O,

at most 4% of K₂O,

0% to 3% of ZrO₂,

0% to 0.3% of TiO₂, and

0.02% to 0.4% of SO₃; and

having a temperature T₂ at which a viscosity of a glass melt is 100 dPa·sec of 1530° C. or lower.

Here, the glass may be a glass applicable to a chemical strengthening treatment, having a depth of a compressive stress layer of 8 μm or more and a surface compressive stress of 500 MPa or more, in a chemically strengthened main surface thereof when being processed for the chemical strengthening treatment.

Regarding the glass, when a refractive index at a room temperature of the glass is referred to as R₁ and when a refractive index at the room temperature of the glass, after kept at a temperature higher by about 100° C. than a glass transition point for 10 minutes and then annealed to the room temperature at a rate of 1° C./min, is referred to as R₂, R₂-R₁ may be 0.0003 or more and 0.0012 or less.

The glass may be one produced according to a float process.

In addition, the present invention provides a glass for chemical strengthening

containing, as expressed by mass percentage based on oxides:

60% to 75% of SiO₂,

3% to 9% of Al₂O₃,

2% to 10% of MgO,

3% to 10% of CaO,

10% to 18% of Na₂O,

at most 4% of K₂O,

0% to 3% of ZrO₂,

0% to 0.3% of TiO₂, and

0.02% to 0.4% of SO₃; and

having a temperature T₂ at which a viscosity of a glass melt is 100 dPa·sec of 1530° C. or lower.

Regarding the glass for chemical strengthening, when a refractive index at a room temperature of the glass for chemical strengthening is referred to as R₁ and when a refractive index at the room temperature of the glass for chemical strengthening, after kept at a temperature higher by about 100° C. than a glass transition point for 10 minutes and then annealed to the room temperature at a rate of 1° C./min, is referred to as R₂, R₂-R₁ may be 0.0003 or more and 0.0012 or less.

The glass for chemical strengthening may be one produced according to a float process.

### Advantageous Effects of Invention

The present invention can provide a glass having a high strength and capable of relatively lowering the melting temperature in glass production.

### BRIEF DESCRIPTION OF DRAWINGS

FIG. 1 is a view schematically illustrating a flow of a production method for a first glass according to the present invention.

FIG. 2 is a view showing crack initiation test results of chemically strengthened samples of Example 1 and Example 9.

FIG. 3 is a view showing crack initiation test results of chemically strengthened samples of Example 16 subjected to a cooling at a different cooling rate.

FIG. 4 is a view showing crack initiation test results of chemically strengthened samples of Example 17 subjected to a cooling at a different cooling rate.

FIG. 5 is a view showing crack initiation test results of chemically strengthened samples of Example 18 subjected to a cooling at a different cooling rate.

FIG. 6 is a view showing crack initiation test results of a glass having a composition of Example 1 subjected to a cooling at a different cooling rate.

### DESCRIPTION OF EMBODIMENTS

An embodiment of the present invention is described below. The following embodiment is shown here as an example, and within a range not overstepping the object of the present invention, various modifications can be made therein for performing it.

### (Regarding Glass of One Embodiment of Invention)

One embodiment of the present invention provides a chemically strengthened glass

containing, as expressed by mass percentage based on oxides:

60% to 75% of SiO₂,

3% to 9% of Al₂O₃,

2% to 10% of MgO,

3% to 10% of CaO,

10% to 18% of Na₂O,

at most 4% of K₂O,

0% to 3% of ZrO₂,

0% to 0.3% of TiO₂, and

0.02% to 0.4% of SO₃;

having a temperature T₂ at which a viscosity of a glass melt is 100 dPa·sec of 1530° C. or lower; and

in the chemically strengthened main surface thereof, having a depth of a compressive stress layer of 8 μm or more, and a surface compressive stress of 500 MPa or more (hereinafter referred to as “the first glass of the present invention”).

As described above, in the field of display devices, a cover glass is desired that has a high strength enough to prevent the cover glass and also the display device itself from being broken even when display devices are incautiously dropped down during use or transport thereof by users.

Accordingly, for increasing the strength of a cover glass, it is considered to apply chemical strengthening treatment to the cover glass.

Here, “chemical strengthening treatment (method)” refers to a general term for a technique of immersing a glass to be treated in an alkali metal-containing molten salt to thereby substitute the alkali metal (ion) having a small atomic diameter existing in the outermost surface of the glass with the alkali metal (ion) having a large atomic diameter existing in the molten salt. In the “chemical strengthening method”, an alkali metal (ion) having a larger atomic diameter than that of the original atom is arranged in the surface of the processed glass. Accordingly, a compressive stress layer may be formed on the surface of the glass, by which the glass strength is increased.

For example, in the case where a cover glass contains sodium (Na), this sodium is substituted with, for example, potassium (Ka) in a molten salt (for example, a nitrate) during chemical strengthening treatment. Alternatively, for example, in the case where a cover glass contains lithium (Li), this lithium may be substituted with, for example, sodium (Na) and/or potassium (Ka) in a molten salt (for example, a nitrate) during chemical strengthening treatment.

In that manner, when a cover glass is processed for chemical strengthening treatment, a chemically strengthened layer (also referred to as “compressive stress layer”) is formed on the surface thereof, and it is considered that the strength of the cover glass could be thereby increased.

However, a cover glass formed of soda lime could not form a thick chemically strengthened layer even though subjected to chemical strengthening treatment, and therefore there is a problem that the strength of the cover glass is difficult to greatly improve.

On the other hand, for solving the problem, it may be taken into consideration to use a glass having a composition capable of readily enjoying the effect of chemical strengthening treatment, such as an aluminosilicate glass, as a cover glass. When the glass of the type is subjected to chemical strengthening treatment, a relatively thick chemically strengthened layer may be formed thereon.

However, in general, the viscosity of the glass melt of an aluminosilicate glass is relatively high, therefore requiring a high temperature in glass production. Consequently, there is a problem in that the brick life of the glass melting furnace is shortened. In addition, when the viscosity of the glass melt is high, bubbles are difficult to be discharged and bubble defects may therefore increase, and foreign substance defects due to unmolten materials may increase, and hence there may be a probability of causing problems as cover glasses.

In this regard, the first glass of the present invention has, though the composition thereof is close to soda lime, a characteristic feature of further containing alumina (Al₂O₃) in an amount of 3% to 9% (as expressed by mass percentage based on oxides; the same shall apply hereinunder).

The first glass of the present invention contains alumina in the amount as above, and therefore can form a relatively thick chemically strengthened layer on the surface of the glass in chemical strengthening treatment. More specifically, in the first glass of the present invention, the chemically strengthened layer existing in the surface thereof has a thickness of 8 μm or more (also referred to as “the depth of the compressive stress layer”), and the surface compressive stress therein is 500 MPa or more.

The first glass of the present invention has such a “thick” chemically strengthened layer, and therefore has a significantly high strength. Accordingly, for example, in the case where the first glass of the present invention is applied to a cover glass of a display device, the above-mentioned problem, that is, the problem that the cover glass is broken when a display device is dropped down can be significantly relieved.

In the first glass of the present invention, the amount of alumina is controlled to fall within a range of 3% to 12%, different from that in an ordinary aluminosilicate glass. Accordingly, the viscosity of the glass melt of the first glass of the present invention can be made smaller than that of an aluminosilicate glass.

As in the above, according to the first glass of the present invention, there can be provided a glass having a high strength and being capable of relatively lowering the melting temperature in glass production.

### (Regarding Composition of First Glass of Invention)

Next, the composition of the first glass of the present invention having the characteristics as mentioned above is described in detail. Here, the composition of the glass before being subjected to chemical strengthening treatment is described.

The first glass of the present invention contains SiO₂, Al₂O₃, MgO, CaO, Na₂O, and SO₃.

SiO₂ is known as a component to form a network structure in a glass microstructure, and is a main component to constitute a glass.

The content of SiO₂ is 60% or more, preferably 66% or more, more preferably 66.5% or more, and even more preferably 67% or more. The content of SiO₂ is 75% or less, preferably 73% or less, more preferably 71.5% or less, and even more preferably 71% or less. When the content of SiO₂ is 60% or more, it is advantageous in point of stability and weather resistance as a glass. On the other hand, when the content of SiO₂ is 75% or less, it is advantageous in point of meltability and formability.

Al₂O₃ has an effect of improving ion exchangeability in chemical strengthening treatment, and especially the effect thereof for improving surface compressive stress is great. It is also known as a component for improving the weather resistance of glass. In addition, it has an effect of inhibiting invasion of tin from the bottom surface in forming according to a float process. Further, it has an effect of promoting dealkalization in performing SO₂ treatment.

The content of Al₂O₃ is 3% or more, preferably 3.8% or more and more preferably 4.2% or more. The content of Al₂O₃ is 9% or less, preferably 8% or less, more preferably 7.5% or less, and even more preferably 7% or less. When the content of Al₂O₃ is 3% or more, a desired surface compressive stress value can be obtained through ion exchange, and the effect of preventing invasion of tin and the effect of promoting dealkalization can also be realized. On the other hand, when the content of Al₂O₃ is 9% or less, the devitrification temperature would not rise so greatly even when the viscosity of glass is high, which is therefore advantageous in point of melting and forming in a soda lime glass production line.

MgO is a component for stabilizing a glass, and is indispensable.

The content of MgO is 2% or more, preferably 3.6% or more, more preferably 3.9% or more, and even more preferably 4% or more. The content of MgO is 10% or less, preferably 6% or less, more preferably 5.7% or less, even more preferably 5.4% or less, still more preferably 5% or less, and further more preferably 4.5% or less. When the content of MgO is 2% or more, the meltability at a high temperature is good and devitrification would hardly occur. On the other hand, when the content of MgO is 10% or less, the property that devitrification hardly occurs could be maintained and a sufficient ion-exchanging rate could be realized.

CaO is a component for stabilizing a glass, and is indispensable. CaO tends to inhibit alkali ion exchange, and especially when DOL is desired to be increased, the content thereof is preferably reduced. On the other hand, for enhancing chemical resistance and devitrification property, it is 3% or more, preferably 4% or more, more preferably 5% or more, even more preferably 6% or more, still more preferably 6.7% or more, and further more preferably 6.9% or more. In turn, the content of CaO is 10% or less, preferably 8.5% or less and more preferably 8.2% or less. When the content of CaO is 3% or more, the meltability at a high temperature is good and devitrification would hardly occur. On the other hand, when the content of CaO is 10% or less, a sufficient ion-exchanging rate could be realized and a chemically strengthened layer having a desired thickness could be obtained.

For making devitrification difficult to occur, the molar concentration of CaO is preferably so selected as to be larger than the molar concentration of MgO by at least 0.5 times the latter, more preferably so selected as to be larger by at least 0.8 times. Even more preferably, the molar concentration of CaO is so selected as to be larger than the molar concentration of MgO. The ratio by mass is preferably CaO/MgO>0.7, more preferably CaO/MgO>1.1 and even more preferably CaO/MgO>1.4 for making devitrification difficult to occur.

Na₂O is an indispensable component for forming a chemically strengthened layer through ion exchange. In addition, it is a component for lowering the high-temperature viscosity and the devitrification temperature of glass, and improving the meltability and formability of glass.

The content of Na₂O is 10% or more, preferably 13.4% or more, more preferably 13.8% or more, even more preferably 14.0% or more, and most preferably 14.5% or more. In turn, the content of Na₂O is 18% or less, typically 16% or less, preferably 15.6% or less, and more preferably 15.2% or less. When the content of Na₂O is 10% or more, a desired chemically strengthened layer can be formed through ion exchange treatment. On the other hand, when the content of Na₂O is 18% or less, sufficient weather resistance can be realized, the amount of tin to invade from the bottom surface in forming according to a float process can be reduced and the glass can be made to be hardly warped after chemical strengthening treatment.

K₂O is effective for increasing the ion exchanging rate and thereby thickening the chemically strengthened layer, and therefore may be contained in an amount of 4% or less. When it is 4% or less, sufficient surface compressive stress can be realized. When K₂O is contained, it is preferably 2% or less, more preferably 1% or less and even more preferably 0.8% or less. In addition, a small amount of K₂O is effective for preventing invasion of tin from the bottom surface in a float forming, and therefore it is preferably contained in forming according to a float process. In this case, the content of K₂O is preferably 0.05% or more and more preferably 0.1% or more.

Though not indispensable, ZrO₂ is generally known to have an effect of increasing the surface compressive stress in chemical strengthening treatment. However, even when ZrO₂ is contained, the effect thereof is not so large relative to cost increase. Accordingly, within a range of acceptable cost allocation, it is desirable that ZrO₂ is contained in an arbitrary ratio. When ZrO₂ is contained, it is preferably at most 3%.

TiO₂ much exists in natural raw materials, and is known to be a coloring source of yellow. The content of TiO₂ is 0.3% or less, preferably 0.13% or less and more preferably 0.1% or less. When the content of TiO₂ exceeds 0.3%, the glass becomes yellowish.

B₂O₃ may be contained within a range of 4% or less for improving the meltability at a high temperature or the strength of the glass. It is preferably 3% or less, more preferably 2% or less and even more preferably 1% or less. In general, when B₂O₃ is contained together with an alkali component of Na₂O or K₂O, evaporation thereof may occur vigorously to greatly corrode bricks. Therefore, it is preferable that B₂O₃ is not substantially contained.

The wording “substantially not containing” as referred to herein means that the component is not contained except unavoidable impurities contained in the raw material or the like, that is, the component is not intentionally incorporated.

Li₂O is a component that lowers the strain point to facilitate stress relaxation, therefore making it difficult to obtain a stable surface compressive stress layer. Therefore, it is preferably not contained. Even when contained, the content thereof is preferably less than 1%, more preferably 0.05% or less and even more preferably less than 0.01%.

Though not an indispensable component, Fe₂O₃ exists anywhere in the natural world and production lines, and therefore it is a component extremely difficult to make the content thereof zero. It is known that Fe₂O₃ in an oxidized state causes coloration in yellow and FeO in a reduced state causes coloration in blue, and it is also known that glass may color in green depending on the balance of the two.

In the case where the first glass of the present invention is used as a cover glass, deep coloring thereof is undesirable. When the total iron amount (total Fe) is calculated as Fe₂O₃, the content thereof is preferably 0.15% or less, more preferably 0.13% or less and even more preferably 0.11% or less. For obtaining a clearer glass, it is preferably 0.04% or less and more preferably 0.02% or less. On the other hand, when the content of Fe₂O₃ is extremely small, the life of bricks to constitute a furnace may be shortened owing to the increase in the paver temperature of the furnace. Consequently, the content of Fe₂O₃ is preferably 0.005% or more, more preferably 0.03% or more and even more preferably 0.05% or more.

SO₃ is a clarifying agent in melting a glass. In general, the content thereof in a glass is not more than a half of the amount to be given by the raw material thereof.

The content of SO₃ in the glass is 0.02% or more, preferably 0.05% or more and more preferably 0.1% or more. In turn, the content of SO₃ is 0.4% or less, preferably 0.35% or less and more preferably 0.3% or less. When the content of SO₃ is 0.02% or more, the glass can be sufficiently clarified to remove babble defects. On the other hand, when the content of SO₃ is 0.4% or less, defects of sodium sulfate formed in the glass may be inhibited.

Here, the value calculated by dividing the content of Na₂O by the content of Al₂O₃ (Na₂O/Al₂O₃) is preferably 7.0 or less. When the value of Na₂O/Al₂O₃ is 7.0 or less, the compressive stress layer can be readily thickened, and therefore a good strength in the crack initiation test to be mentioned below can be provided. The value of Na₂O/Al₂O₃ is more preferably 6.0 or less and even more preferably 5.0 or less. On the other hand, when the value of Na₂O/Al₂O₃ is 2.1 or more, the glass viscosity does not increase and the production is therefore easy, and thus it is preferable. The value of Na₂O/Al₂O₃ is more preferably 2.2 or more, even more preferably 2.3 or more and still more preferably 2.4 or more.

The value calculated by dividing the total content of Na₂O and K₂O by the content of Al₂O₃ ((Na₂O+K₂O)/Al₂O₃) is preferably 7.0 or less. When the value of (Na₂O+K₂O)/Al₂O₃ is 7.0 or less, the compressive stress layer can be readily thickened, and therefore a good strength in the crack initiation test to be mentioned below can be provided. The value of (Na₂O+K₂O)/Al₂O₃ is more preferably 6.0 or less and even more preferably 5.0 or less. On the other hand, when the value of (Na₂O+K₂O)/Al₂O₃ is 2.1 or more, the glass viscosity does not increase and the production is therefore easy, and thus it is preferable. The value of (Na₂O+K₂O)/Al₂O₃ is more preferably 2.2 or more, even more preferably 2.3 or more and still more preferably 2.4 or more.

In addition, the first glass of the present invention may contain, for example, a coloring component such as Co, Cr, Mn or the like, as well as Zn, Sr, Ba, Cl, F or the like, in a total of 3% or less within a range not losing the advantageous effects of the invention.

### (Regarding Characteristics of First Glass of Invention)

Next, the characteristics of the first glass of the present invention are described in detail.

### (Viscosity of Glass Melt)

The first glass of the present invention has the above-mentioned composition and therefore the viscosity of the glass melt is relatively low. Specifically, regarding the first glass of the present invention, the temperature T₂ at which the viscosity of the glass melt is 100 dPa·sec is 1530° C. or lower.

The temperature T₂ is preferably 1510° C. or lower, more preferably 1500° C. or lower or even more preferably 1490° C. or lower.

Similarly, since it has the above-mentioned composition, the viscosity of the glass melt is relatively low, and regarding the first glass of the present invention, the temperature T₄ at which the viscosity of the glass melt is 10⁴ dPa·sec is preferably 1100° C. or lower.

The temperature T₂ may be measured by using a rotational viscometer, etc.

### (Glass Transition Point)

In the first glass of the present invention, the glass transition temperature is preferably 530° C. or higher, more preferably 540° C. or higher and even more preferably 550° C. or higher. Also preferably, it is 600° C. or lower. By having the glass transition point of 530° C. or higher, it is advantageous in point of preventing stress relaxation and preventing thermal warping in chemical strengthening treatment. The control of the glass transition point may be possible by controlling the total amount of SiO₂ and Al₂O₃ and the amount of Na₂O and K₂O, or the like.

### (Thermal Expansion Coefficient)

In the first glass of the present invention, the mean linear thermal expansion coefficient (thermal expansion coefficient) at 50 to 350° C. is preferably 80 to 100×10⁻⁷° C.⁻¹ and more preferably 80 to 95×10⁻⁷° C.⁻¹. By having the thermal expansion coefficient of 80×10⁻⁷° C.⁻¹ or more, it is advantageous in point of matching of the thermal expansion coefficient with metals and other substances. By having the thermal expansion coefficient of 100×10⁻⁷° C.⁻¹ or less, it is advantageous in point of thermal shock resistance, warping property or the like. The control of the thermal expansion coefficient may be possible by controlling the amount of Na₂O and K₂O, or the like.

The thermal expansion coefficient of an ordinary soda lime glass is generally a value of 85 to 93×10⁷° C.⁻¹ at a temperature falling within a range of 50 to 350° C. Glass for displays is processed in various steps of film formation, sheet bonding and the like to be products of information instruments, etc. During the process, it is desired that the thermal expansion coefficient does not deviate greatly from an ordinary value.

### (Mean Cooling Rate)

In the first glass of the present invention, the structural temperature of the glass is preferably low for increasing the surface compression stress after chemical strengthening treatment. The atoms in a glass have an array structure of a liquid phase state, and the temperature at which the structure is frozen is referred to as a structural temperature. The structural temperature of a glass is influenced by the cooling rate from around the annealing point of a glass down to around 400° C., and by gradually annealing, the structural temperature is lowered and the glass having the same composition can have an increased density. A glass having an increased density may have larger compressive stress generated in ion exchange treatment. On the other hand, when the density of a glass is too high, cracks may readily occur in contact with an object. The present inventors have found that, even after chemical strengthening treatment, the feature of the glass having a low density before chemical strengthening, that is, the feature of the glass having a high structural temperature is important for making the crack hardly occurs. Accordingly, for realizing the excellent strength resistant to cracking in contact with an object, a glass that has been produced at a suitable cooling rate and has a suitable glass structural temperature is important.

The mean cooling rate of a glass can be estimated according to the following process. A test where a glass is kept at a temperature higher by around 100° C. than the glass transition point for 10 minutes, and then cooled at a predetermined cooling rate, are performed at 0.1° C./min, 1° C./min, 10° C./min, 100° C./min and 1000° C./min and the refractive index of every glass is measured. The relationship between the refractive index and the cooling rate can be obtained as a calibration curve. Subsequently, the refractive index of the actual sample is measured, and the cooling rate thereof is obtained from the calibration curve. In this description, the cooling rate determined according to this method is referred to as “mean cooling rate at around glass transition point”, or simply as “mean cooling rate”.

In the first glass of the present invention, the mean cooling rate at around the glass transition point is preferably 10° C./min or more for elevating the structural temperature of the glass to thereby make the crack hardly occurs. It is more preferably 15° C./min or more and even more preferably 20° C./min or more. On the other hand, for increasing the surface compressive stress after chemical strengthening treatment, it is preferably less than 150° C./min, more preferably 130° C./min or less and even more preferably 100° C./min or less.

From the viewpoint of continuous production at a suitable mean cooling rate, it is desirable that the first glass of the present invention is produced according to a float process.

The change of the structural temperature of glass can be estimated by the change of the refractive index of glass as a simple method. First, the refractive index (R₁) of a glass at room temperature (for example, 25° C.) is measured. The glass is kept at a temperature higher by around 100° C. than the glass transition point for 10 minutes, and then annealed down to room temperature (for example, 25° C.) at a rate of 1° C./min (hereinafter also referred to as re-annealing treatment), and again the refractive index (R₂) of the glass at room temperature is measured. From the difference in refractive index (R₂-R₁) measured before and after the re-annealing treatment, the degree how the structural temperature of the glass was higher than the structural temperature thereof cooled at a rate of 1° C./min can be known.

For measurement of the refractive index of glass, there are known a minimum deviation method, an optimum angle method, a V-block method, etc. Any of these methods is employable for validating the effect of the present invention. Of the first glass of the present invention, the difference in the refractive index before and after re-annealing treatment (R₂-R₁) is preferably 0.0012 or less, more preferably 0.0011 or less and even more preferably 0.0010 or less. When the refractive index difference is more than 0.0012, the structural temperature of the glass is high and the surface compressive stress after chemical strengthening treatment may lower. In addition, of the first glass of the present invention, the refractive index difference before and after re-annealing treatment (R₂-R₁) is preferably 0.0003 or more. With that, cracks may hardly occur in contact with an object and the strength increases. It is more preferably 0.0005 or more and even more preferably 0.0007 or more.

(Chemically Strengthened Layer, that is, Compressive Stress Layer)

The first glass of the present invention is a chemically strengthened glass. The chemically strengthened layer is formed on at least one main surface of the first glass of the present invention.

Here, the “main surface” means the surface having a largest area of the six surfaces of the glass (in general, two surfaces facing each other) in a rectangular plate glass. Of the six surfaces of the glass, portions except the two main surfaces are referred to as “edge surfaces”. The edge surfaces are arranged around the periphery of the glass so as to connect the two main surfaces.

The chemically strengthened layer may be formed on both main surfaces. In addition, the chemically strengthened layer may also be formed on at least one edge surface of the glass. For example, the chemically strengthened layer may be formed on all the six surfaces including all the edge surfaces of the glass.

Here, in the chemically strengthened main surface of the first glass of the present invention, the depth of the compressive stress layer is at least 8 μm. In particular, the depth of the compressive stress layer preferably falls within a range of 9 μm to 25 μm. When the depth of the compressive stress layer exceeds 25 μm, there may occur a problem that it becomes difficult to cut after chemical strengthening treatment. It is more preferably 20 μm or less and even more preferably 18 μm or less, and especially when cuttability is taken into consideration, it is preferably 15 μm or less.

The depth of the compressive stress layer may be evaluated by using a commercially-available surface stress meter.

In the chemically strengthened main surface, the surface compressive stress is 500 MPa or more. The surface compressive stress is preferably 600 MPa or more and more preferably 700 MPa or more.

The surface compressive stress may be evaluated by using a commercially-available surface stress meter.

### (Others)

The dimension of the first glass of the present invention is not specifically limited. The first glass of the present invention may have a thickness of, for example, falling within a range of 0.1 mm to 5 mm. The first glass of the present invention may have a dimension applicable to small-size display devices such as smartphones. In the case, from the viewpoint of weight reduction, one having a small thickness is desired, and the thickness thereof is 2 mm or less, preferably 1.5 mm or less and more preferably 1 mm or less.

### (Production Method for First Glass of Invention)

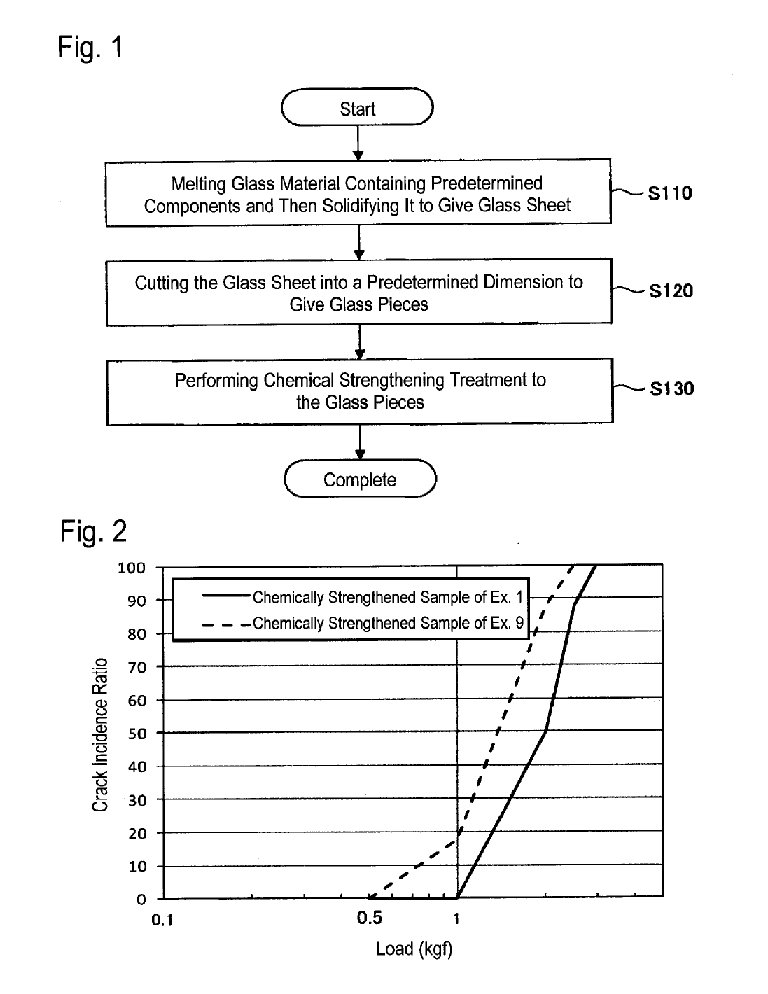

Next, with reference to FIG. 1, one example of a production method for the first glass of the present invention is described briefly. The production method to be described below is a mere one example, and the first glass of the present invention may be produced according to other production methods.

FIG. 1 schematically illustrates a flow of a production method for the first glass of the present invention.

As illustrated in FIG. 1, the production method includes:

(a) a step of melting a glass material containing predetermined components and then solidifying it to give a glass sheet (step S110),

(b) a step of cutting the glass sheet into a predetermined dimension to give glass pieces (step S120) and

(c) a step of performing chemical strengthening treatment to the glass pieces (step S130).

Next, each step is described.

### (Step S110)

First, a glass material is prepared. Next, the glass material is melted to form a molten glass. The melting temperature is not specifically limited. Subsequently, the molten glass is solidified while formed into a tabular form to give a glass sheet.

Here, this series of the process is preferably carried out, for example, according to a float process. In the float process, tin invades into at least one surface, by which the hardness of the surface is increased and the flaw resistance is thereby enhanced. The flaw as referred to in this case does not mean the cracks (flaws) that are evaluated in the crack initiation test to be mentioned below, but means flaws to be formed by plastic deformation. Accordingly, through a predetermined chemical strengthening, the strength can be more readily enhanced in the chemically strengthened glass that contains an Sn component existing in at least one surface of the glass by using the float glass without polishing it.

The glass material is so prepared as to have the above-mentioned composition after melting and solidification. Specifically, the glass material is prepared so that the glass sheet may have a composition containing 60% to 75% of SiO₂, 3% to 9% of Al₂O₃, 2% to 10% of MgO, 3% to 10% of CaO, 10% to 18% of Na₂O, at most 4% of K₂O, 0% to 3% of ZrO₂, 0% to 0.3% of TiO₂, and 0.02% to 0.4% of SO₃.

This composition greatly differs from the composition of an aluminosilicate glass, and is rather close to the composition of a soda lime glass. Accordingly, in the melting step for the glass material, the viscosity of the molten glass can be significantly suppressed. As a result, after solidification of the molten glass, a glass sheet where the components are uniformly dispersed can be produced.

### (Step S120)

Next, the resultant glass sheet is cut into a predetermined dimension. For example, in the case where the first glass of the present invention is used as a cover glass for small-size display devices, in this step, the glass sheet is cut into a dimension of such a cover glass or into a dimension suitable for the production process for cover glasses including a gang-printing step. For the cutting method, a conventional general method may be employed.

Accordingly, glass pieces having a predetermined dimension can be obtained.

This step can be omitted in the case where the glass sheet is produced to have a finally necessary dimension in the previous step S110.

### (Step S130)

Next, the resultant glass pieces are subjected to chemical strengthening treatment.

The condition for the chemical strengthening treatment is not specifically limited so far as it is a condition where a chemically strengthened layer having a thickness of 8 μm or more can be formed on at least one main surface of the glass piece (that is, a condition where the depth of the compressive stress layer can be 8 μm or more).

For example, the chemical strengthening treatment can be carried out by immersing the glass pieces in a molten nitrate salt at 400° C. to 465° C. for a predetermined period of time. As the molten nitrate salt, for example, potassium nitrate (KNO₃) is used. The time for the chemical strengthening treatment is, though not specifically limited, generally about 1 hour to 12 hours. For obtaining a higher surface compressive stress, preferably, potassium nitrate in which the impurity concentration of sodium and the like is low is used. Specifically, the sodium concentration in potassium nitrate is preferably 3% by mass or less and more preferably 1% by mass or less. However, when the sodium concentration is too low, there tends to be formed a difference in the surface compressive stress between the batches of chemical strengthening, and therefore, the sodium concentration in potassium nitrate is preferably 0.05% by mass or more and more preferably 0.1% by mass or more. When the time for chemical strengthening treatment is too long, the surface compressive stress may lower owing to stress relaxation, and therefore, the time for chemical strengthening treatment is preferably 8 hours or less and more preferably 6 hours or less. When the time for chemical strengthening is shorter than 1 hour, the compressive stress depth may shallow and a desired strength would be difficult to be obtained. It is preferably 1.5 hours or more and more preferably 2 hours or more. For the purpose of promoting chemical strengthening and for the purpose of improving quality, additives may be optionally added to potassium nitrate.

It is not always necessary to apply the chemical strengthening treatment to the entire surfaces of the glass pieces. For example, some surfaces (for example, five surfaces) of a glass piece may be masked, followed by performing chemical strengthening treatment, to thereby form a chemically strengthened layer only on the intended surfaces (for example, on one main surface) of the glass piece.

Accordingly, a chemically strengthened layer is formed on a predetermined surface of the glass piece to thereby enhance the strength of the glass piece.

According to the above-mentioned process, the first glass (glass piece) of the present invention can be produced.

In the production process, a glass sheet where the components are uniformly dispersed can be obtained in the step S110.

After produced, the glass piece has an increased strength owing to the chemical strengthening treatment. Accordingly, when the glass piece thus produced is used as a cover glass in display devices, the problem that the cover glass may be broken when the display device is erroneously dropped down can be significantly relieved.

In the above description, the production method for the first glass of the present invention is described with reference to an example where a glass sheet is cut into glass pieces (step S120), and then the glass pieces are subjected to chemical strengthening treatment (step S130).

However, in the production method for the first glass of the present invention, the glass may be further cut after the step S130. In this case, as the cut surfaces of the glass pieces obtained after the step S130, surfaces not treated for chemical strengthening are exposed out. However, even in the case, so far as at least one main surface of the glass piece is chemically strengthened, the glass pieces whose strength has been significantly enhanced as compared with that of glass pieces not subjected to chemical strengthening treatment can be obtained.

### EXAMPLES

Next, examples of the present invention are described. The present invention is not limited to the following examples.

### Example 1 and Example 9

Glasses each having the composition shown in the column of Example 1 and Example 9 in Table 1 were produced to have a sheet thickness of 0.7 mm, according to a float process. The resultant glasses were cut into 10 cm×10 cm, thereby producing tabular glass samples of 10 cm×10 cm×thickness of 0.7 mm. The characteristics of the samples were evaluated. Both of Example 1 and Example 9 are the glasses produced according to a float process, and an Sn component exists in one surface of the each glass.

### Example 2 to Example 8

Glass samples were produced according to the procedure mentioned below, and the characteristics thereof were evaluated.

First, the raw material components were weighed and mixed to give a predetermined composition, thereby preparing glass materials (each about 1 kg) of 7 kinds of compositions (Example 2 to Example 8).

Next, the prepared glass material was put into a platinum crucible, and the crucible was put into a resistance heating electric furnace at 1480° C. The glass material was melted in the furnace, then kept as such for 3 hours, and thus homogenized. Next, the resultant molten glass was cast into a mold and kept therein at a temperature of (glass transition point Tg+50° C.) for 1 hour. Subsequently, this was cooled down to room temperature at a rate of 0.5° C./min to give a glass block. The glass transition point Tg is a value estimated through calculation from the composition.

Further, the glass block was cut into a dimension of 30 mm×30 mm. Subsequently, the resultant glass piece was polished, and further both main surfaces thereof was processed for a mirror-surface state to prepare a tabular glass sample of 30 mm×30 mm×thickness of 1.0 mm.

The following Table 1 collectively shows the compositions of 9 kinds of glass samples (each referred to as “glass sample of Example 1 to Example 9”). Here, the composition in Table 1 indicates the results of fluorescent X-ray analysis.

TABLE 1

| Mass % | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|
| SiO₂ | 68.6 | 68.1 | 68.4 | 68.3 | 69.5 | 69.6 | 69.8 | 69.7 | 71.8 |
| Al₂O₃ | 5.0 | 5.2 | 5.2 | 5.2 | 4.7 | 4.7 | 4.7 | 4.7 | 1.8 |
| CaO | 7.3 | 7.0 | 7.5 | 6.9 | 7.5 | 7.5 | 8.0 | 7.4 | 8.2 |
| MgO | 4.2 | 4.1 | 3.7 | 4.3 | 4.6 | 4.5 | 4.0 | 4.6 | 4.5 |
| Na₂O | 14.7 | 15.0 | 15.0 | 15.1 | 13.5 | 13.2 | 13.3 | 13.4 | 13.4 |
| K₂O | 0.17 | 0.60 | 0.17 | 0.17 | 0.16 | 0.52 | 0.16 | 0.16 | 0.3 |
| TiO₂ | 0.03 | 0.03 | 0.03 | 0.03 | 0.03 | 0.03 | 0.03 | 0.03 | 0.03 |
| ZrO₂ | 0.01 | 0.01 | 0.01 | 0.01 | 0.01 | 0.01 | 0.01 | 0.01 | 0.01 |
| Fe₂O₃ | 0.102 | 0.102 | 0.104 | 0.100 | 0.102 | 0.100 | 0.099 | 0.105 | 0.100 |
| SO₃ | 0.2 | 0.2 | 0.2 | 0.2 | 0.2 | 0.2 | 0.2 | 0.2 | 0.2 |
| Total | 100 | 100 | 100 | 100 | 100 | 100 | 100 | 100 | 100 |
| Na₂O/Al₂O₃ | 2.94 | 2.88 | 2.88 | 2.90 | 2.87 | 2.81 | 2.83 | 2.85 | 7.4 |
| (Na₂O + K₂O)/Al₂O₃ | 2.97 | 3.00 | 2.92 | 2.94 | 2.91 | 2.92 | 2.86 | 2.89 | 7.6 |
| Specific Gravity | 2.5019 | 2.5024 | 2.5041 | 2.501 | 2.4984 | 2.4975 | 2.4998 | 2.4976 | 2.4979 |
| Thermal Expansion Coefficient | 91 | 94 | 93 | 92 | 87 | 88 | 88 | 87 | 87 |
| (10⁻⁷° C.⁻¹) | | | | | | | | | |
| Glass Transition Point (° C.) | 556 | 554 | 557 | 557 | 568 | 564 | 567 | 567 | — |
| Strain Point (° C.) | 512 | 517 | 521 | 518 | 526 | 525 | 530 | 526 | 521 |
| T₂(° C.) | 1473 | 1476 | 1478 | 1480 | 1471 | 1488 | 1489 | 1492 | 1466 |
| T₄(° C.) | 1042 | 1042 | 1043 | 1045 | 1058 | 1057 | 1057 | 1059 | 1045 |
| T_{L}(° C.) | 1015 | 1005 | 1015 | 1020 | 1065 | 1060 | 1045 | 1070 | — |
| T₄-T_{L}(° C.) | 27 | — | — | — | −7 | — | — | — | — |
| Photoelastic Coefficient | 27.1 | 26.8 | 26.9 | 26.9 | 27.1 | 27.0 | 27.0 | 27.1 | 26.9 |
| (nm · cm/MPa) | | | | | | | | | |
| Refractive Index | 1.518 | 1.515 | 1.515 | 1.515 | 1.515 | 1.515 | 1.515 | 1.5148 | 1.5143 |

In Table 1, the numerals in some evaluation result columns are italic. This means that the values thereof are values calculated from the composition.

### (Characteristics Evaluation)

Next, the characteristics of the produced glass samples were evaluated.

The above Table 1 collectively shows the characteristics evaluation results obtained in the glass samples.

The characteristics in Table 1 are the results measured according to the following methods.

Specific gravity: Archimedes' method

Thermal expansion coefficient: The mean linear thermal expansion coefficient at 50 to 350° C. is obtained according to a TMA method.

Glass transition point Tg: TMA method

Strain point: Fiber elongation method

Temperature T₂ and temperature T₄: Each glass sample is melted, and by using a rotational viscometer, the viscosity of the molten glass is measured. The temperature at which the viscosity is 100 dPa·sec was represented by T₂ (° C.), and the temperature at which the viscosity is 10⁴ dPa·sec was represented by T₄ (° C.).

Devitrification temperature T_{L}: The glass sample was ground into glass grains of about 2 mm in a mortar, and the glass grains were spread in a platinum boat, and heat-treated at intervals of 5° C. for 24 hours in a temperature gradient furnace. The maximum value of the temperature of the glass grains in which crystals are deposited is referred to as the devitrification temperature T_{L}.

Photoelastic coefficient and refractive index: These are calculated by regression calculation from the composition of the glass.

In Table 1, the numerals in some evaluation result columns are italic. This means that the values thereof are values calculated from the composition.

From Table 1, it was known that, in the case of the glass samples of Example 1 to Example 9, the temperature T₂ at which the viscosity is 100 dPa·sec is 1530° C. or lower in all cases.

### Example 10 to Example 15

Glass samples were produced according to the procedure mentioned below, and the characteristics thereof were evaluated.

First, the raw material components were weighed and mixed to give a predetermined composition, thereby preparing glass materials (each about 500 g) of 6 kinds of compositions (Example 10 to Example 15).

Next, the prepared glass material was put into a platinum crucible, and the crucible was put into a resistance heating electric furnace at 1480° C. The glass material was melted in the furnace, then kept as such for 3 hours, and thus homogenized. Next, the resultant molten glass was cast into a mold and kept therein at a temperature of 600° C. for 1 hour. Subsequently, this was cooled down to room temperature at a rate of 1° C./min to give a glass block.

Further, the glass block was cut into a dimension of 50 mm×50 mm. Subsequently, the resultant glass piece was polished, and further both main surfaces thereof was processed for a mirror-surface state to prepare a tabular glass sample of 50 mm×50 mm×thickness of 3 mm.

The following Table 2 collectively shows the compositions of 6 kinds of glass samples (each referred to as “glass sample of Example 10 to Example 15”). Here, the composition in Table 2 indicates the results of fluorescent X-ray analysis.

TABLE 2

| Mass % | Ex. 10 | Ex. 11 | Ex. 12 | Ex. 13 | Ex. 14 | Ex. 15 |
|---|---|---|---|---|---|---|
| SiO₂ | 70.5 | 69.5 | 68.4 | 67.5 | 70.2 | 60.8 |
| Al₂O₃ | 3.0 | 4.0 | 5.0 | 6.0 | 3.5 | 9.6 |
| CaO | 7.5 | 7.5 | 7.5 | 7.5 | 7.5 | 0.0 |
| MgO | 4.8 | 4.4 | 3.9 | 3.4 | 4.7 | 7.0 |
| Na₂O | 14.2 | 14.6 | 15.2 | 15.6 | 13.6 | 11.7 |
| K₂O | 0.0 | 0.0 | 0.0 | 0.0 | 0.5 | 5.9 |
| TiO₂ | 0.03 | 0.03 | 0.03 | 0.03 | 0.03 | |
| ZrO₂ | 0.01 | 0.01 | 0.01 | 0.01 | 0.01 | 0.20 |
| Fe₂O₃ | 0.10 | 0.10 | 0.10 | 0.10 | 0.10 | |
| SO₃ | 0.2 | 0.2 | 0.2 | 0.2 | 0.2 | 4.8 |
| Total | 100 | 100 | 100 | 100 | 100 | 100 |
| Na₂O/Al₂O₃ | 4.73 | 3.65 | 3.04 | 2.60 | 3.89 | 1.22 |
| (Na₂O + K₂O)/Al₂O₃ | 4.73 | 3.65 | 3.04 | 2.60 | 4.02 | 1.83 |
| Specific Gravity | 2.5015 | 2.5060 | 2.5104 | 2.5149 | 2.5016 | 2.53 |
| Thermal Expansion Coefficient | 88.5 | 90.2 | 91.8 | 93.5 | 88.0 | 91 |
| (10⁻⁷° C.⁻¹) | | | | | | |
| Glass Transition Point (° C.) | | | | | | |
| Strain Point (° C.) | 518 | 519 | 521 | 523 | 521 | |
| T₂(° C.) | 1466 | 1470 | 1474 | 1478 | 1476 | 1575 |
| T₄(° C.) | 1043 | 1043 | 1042 | 1041 | 1050 | 1168 |
| T_{L}(° C.) | | | | | | |
| T₄-T_{L}(° C.) | | | | | | |
| Photoelastic Coefficient | | | | | | |
| (nm · cm/MPa) | 26.9 | 26.8 | 26.8 | 26.8 | 26.9 | |
| Refractive Index | 1.5149 | 1.5153 | 1.5158 | 1.5163 | 1.5150 | |

In Table 2, the evaluation results are all values calculated from the composition.

From Table 2, it was known that, in the case of the glass samples of Example 10 to Example 14, the temperature T₂ at which the viscosity is 100 dPa·sec is 1530° C. or lower in all cases. On the other hand, it was known that, in the case of the glass sample of Example 15, the temperature T₂ at which the viscosity thereof is 100 dPa·sec exceeds 1530° C.

### (Chemical Strengthening Treatment)

Chemical strengthening treatment was performed to the glass samples of Example 1 and Example 9 were.

Regarding the glass of Example 1, the mean cooling rate at around the glass transition point, as measured according to the above-mentioned method, was 63° C./min, and the refractive index difference before and after the re-annealing treatment (R2-R1) was 0.00094.

The chemical strengthening treatment was carried out by entirely immersing the glass sample in a molten salt of potassium nitrate at 410° C. for 180 minutes. The Na concentration in the molten potassium nitrate salt was 0.283%.

The glass samples after the chemical strengthening treatment (hereinafter each referred to as “chemically strengthened sample of Example 1” and “chemically strengthened sample of Example 9”) were analyzed to measure the depth of the compressive stress layer and the surface compressive stress therein.

The measurement of the depth of the surface compressive layer and the surface compressive stress was carried out by using a surface stress meter (manufactured by Orihara Manufacturing Co., Ltd.; FSM-6000).

The measurement results are shown in Table 3.

TABLE 3

| | Ex. 1 | Ex. 9 |
|---|---|---|
| Thickness of Chemically | 8.7 | 3.0 |
| Strengthened Layer (μm) | | |
| Compressive Stress (MPa) | 685 | 585 |

As shown in Table 3, in the case of the chemically strengthened sample of Example 1, the depth of the compressive stress layer was 8.7 μm, and it was known that a sufficiently thick compressive stress layer was formed. On the other hand, in the case of the chemically strengthened sample of Example 9, the depth of the compressive stress layer was 3.0 and it was known that the compressive stress layer was not very thick.

### (Crack Initiation Test 1)

By using the chemically strengthened samples of Example 1 and Example 9, a crack initiation test was carried out. This test is an evaluation method which can compare the easiness in cracking of glass. From the results of the test, the breaking resistance of cover glasses in dropping down can be estimated.

By using a Vickers' hardness tester, this test is carried out as follows.

First, in an atmosphere in which the moisture dew point is −30° C., a Vickers' indenter is compressed to the surface of the sample under a predetermined load for 15 seconds. Next, the Vickers' indenter is removed. A rhombic indentation is formed on the surface of the sample. The four corners of the indentation are observed. Each corner is checked for the presence or absence of cracks, and the crack incidence ratio P (%) is calculated.

For example, when cracks are observed in only one corner out of the four corners, the crack incidence ratio is 25%. When cracks are observed in two corners, the crack incidence ratio is 50%. Further, when cracks are observed in three corners, the crack incidence ratio is 75%. When cracks are observed in all corners, the crack incidence ratio is 100%.

In the present example, crack initiation test was performed for 10 times under the same load by using the same sample, and the mean value of the resultant crack incidence ratio was referred to as the crack incidence ratio P (%) under the load.

The load of the Vickers' indenter was 500 gf, 1 kgf, 2 kgf, 2.5 kgf, and 3 kgf.

The crack initiation test results of the chemically strengthened samples of Example 1 and Example 9 are collectively shown in FIG. 2. In FIG. 2, the horizontal axis indicates the load of the Vickers' indenter (kgf), and the vertical axis indicates the crack incidence ratio P (%).

As shown in FIG. 2, in the chemically strengthened sample of Example 1, the crack incidence ratio P under a load of up to 1 kgf was 0%, and it was known that a good strength is provided. On the other hand, in the chemically strengthened sample of Example 9, the crack incidence ratio P under a load of 1 kgf was about 20%. In particular, it was known that the chemically strengthened sample of Example 9 has a large crack incidence ratio P as compared with the chemically strengthened sample of Example 1 irrespective of the load given thereto.

This results from the difference in the depth of the compressive stress layer. Specifically, in the chemically strengthened sample of Example 1, the compressive stress layer is sufficiently thick, and therefore a relatively good strength can be obtained. As opposed to this, in the chemically strengthened sample of Example 9, a significantly thick compressive stress layer could not be formed, and therefore it is considered that, even after performing the chemical strengthening treatment, an increase in the strength was not observed very much.

The above confirmed that, when the value of Na₂O/Al₂O₃ is 7.0 or less, the compressive stress layer can be readily thickened, and therefore in the crack initiation test, a good strength was provided.

### (Crack Initiation Test 2)

Glass samples having the three kinds of composition shown in Table 4 (each referred to as “glass sample of Example 16 to Example 18”) were prepared. The production method is the same as the method of producing the glass sample of Example 10 and the like. Here, the compositions shown in Table 4 are the results of fluorescent X-ray analysis.

TABLE 4

| Mass % | Ex. 16 | Ex. 17 | Ex. 18 |
|---|---|---|---|
| SiO₂ | 65.6 | 65.0 | 67.3 |
| Al₂O₃ | 5.3 | 8.0 | 5.8 |
| CaO | 1.0 | 3.0 | 4.7 |
| MgO | 9.4 | 4.1 | 6.2 |
| Na₂O | 16.8 | 17.9 | 15.9 |
| K₂O | 0.0 | 0.0 | 0.0 |
| TiO₂ | 0.0 | 0.0 | 0.0 |
| ZrO₂ | 1.9 | 2.0 | 0.0 |
| Fe₂O₃ | 0.10 | 0.10 | 0.10 |
| SO₃ | 0.2 | 0.2 | 0.2 |
| Total | 100 | 100 | 100 |
| Na₂O/Al₂O₃ | 3.2 | 2.2 | 2.7 |
| (Na₂O + K₂O)/Al₂O₃ | 3.2 | 2.2 | 2.7 |
| Specific Gravity | 2.506 | 2.507 | 2.495 |
| Thermal Expansion Coefficient | 91 | 97 | 91 |
| (10⁻⁷ ° C.⁻¹) | | | |
| Glass Transition Point (° C.) | 582.9 | 538 | 566 |
| Strain Point (° C.) | | | |
| T₂ (° C.) | 1456 | 1493 | 1459 |
| T₄ (° C.) | 1069 | 1076 | 1050 |
| T_{L} (° C.) | 1042 | <980 | |
| T₄-T_{L} (° C.) | 27 | >96 | |
| Photoelastic Coefficient | | | |
| (nm · cm/MPa) | | | |
| Refractive Index | | | |

The glass samples of Example 16 to Example 18 were treated for the above-mentioned chemical strengthening treatment. The measurement of the depth of the compressive stress layer and the surface compressive stress was carried out by using a surface stress meter (manufactured by Orihara Manufacturing Co., Ltd.; FSM-6000). The measurement results are shown in Table 5.

TABLE 5

| | Ex. 16 | Ex. 17 | Ex. 18 |
|---|---|---|---|
| Thickness of Chemically | 12.0 | 22.5 | 10.1 |
| Strengthened Layer (μm) | | | |
| Compressive Stress (MPa) | 844 | 627 | 729 |

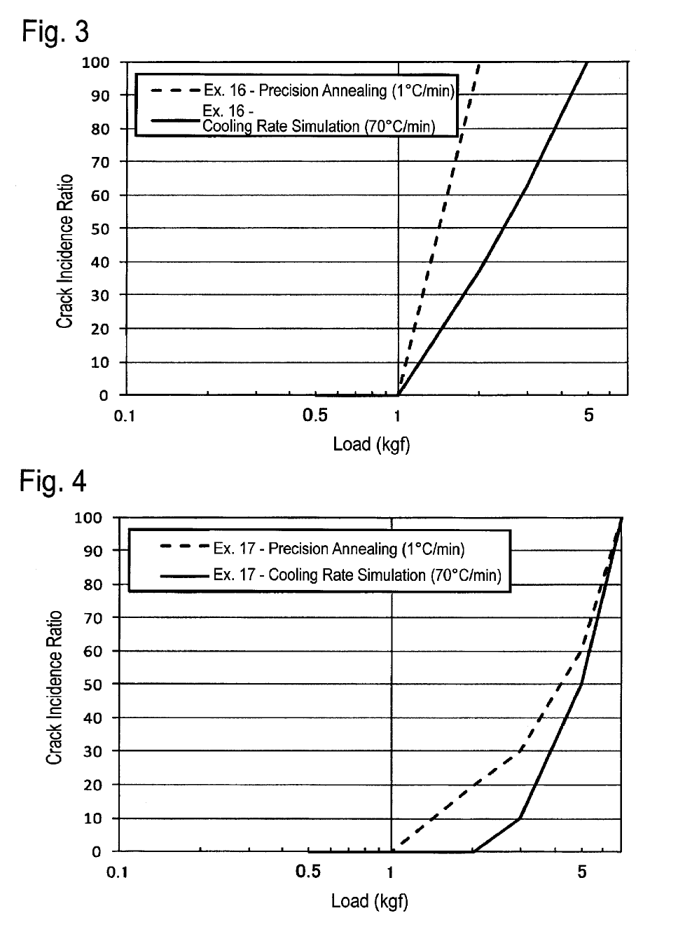

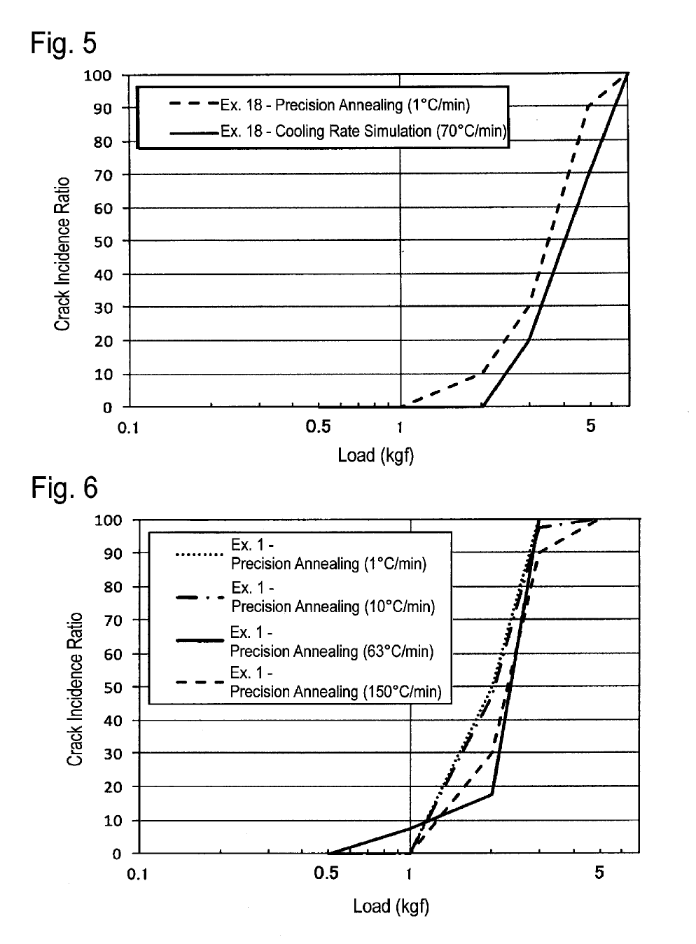

By using the chemically strengthened samples, a crack initiation test was carried out. This test was the same method as that of the crack initiation test 1, but in this, the condition was partly varied (the moisture dew point was room temperature). Here, for clearly understanding the difference between the glass obtained in a laboratory and the glass obtained in practical float forming, two glass samples were prepared in each of Example 16 to Example 18, and the two glass samples of each Example were cooled at a different cooling rate. Concretely, as a glass obtained in a laboratory, one that had been subjected to a precision annealing (1° C./min) was used; while as a glass simulating a glass obtained in a float forming, one that had been subjected to a cooling rate simulation (70° C./min) was used. The difference in the refractive index before and after the re-annealing treatment of these glasses (R2-R1) is around 0.00096 each. The glasses thus obtained under each cooling condition were processed for chemical strengthening treatment, and then subjected to the crack initiation test 2. The results are shown in FIGS. 3 to 5. As a result, in the glasses of Example 16 to Example 18, in the glasses that had been chemically strengthened after the cooling rate simulation (70° C./min) simulated the glass obtained by a float forming, cracks were more hardly occurred under the same indentation load than in the glasses that had been chemically strengthened after precision annealing (PC/min).

### (Crack Initiation Test 3)

Next, the glasses that simulated a glass obtained by a float forming, and the glasses obtained in a laboratory and having the equivalent composition as that of the former were investigated in point of the relationship between the cooling condition and the crack initiation.

Four glasses having the composition of Example 1 were prepared, and individually cooled at any of four different cooling rates, whereby differentiating the cooling rates for the each glass. The four different cooling rates are precision annealing (1° C./min), precision annealing (10° C./min), annealing equivalent to a float forming (63° C./min), and precision annealing (150° C./min) The difference in the refractive index before and after the re-annealing treatment of these glasses (R₂-R₁) was 0, 0.00052, 0.00094, and 0.00113, respectively. By using the glasses thus produced at each cooling rate, the above-mentioned crack initiation test was carried out. The results are shown in FIG. 6.

As shown in FIG. 6, of the glass subjected to precision annealing (1° C./min), the crack incidence ratio after indentation under a load of 2 kgf was 50%, and cracks readily occurred. In the glass subjected to precision annealing (10° C./min), the crack incidence ratio after indentation under a load of 2 kgf was 47.5%, and it was slightly better than the glass subjected to precision annealing (1° C./min). In the glass that had been subjected to annealing equivalent to a float forming (63° C./min), the crack incidence ratio after indentation under a load of 2 kgf was 17.5%, and it was the best of the four glasses. In the glass subjected to precision annealing (150° C./min), the crack incidence ratio after indentation under a load of 2 kgf was 30%, which was good. In consideration of the above-mentioned results and the surface compression stress (so-called CS) that is a characteristic of chemical strengthening, the glass that had been subjected to annealing equivalent to a float forming (63° C./min) was the most excellent glass. The glass subjected to precision annealing (10° C./min) was somewhat inferior in point of the crack initiation test result, but was a practicable glass. On the other hand, the glasses subjected to precision annealing (1° C./min) or precision annealing (150° C./min) were glasses insufficient for a practical use. The glass subjected to precision annealing (1° C./min) was inferior in point of the crack initiation test result, and in the glass subjected to precision annealing (150° C./min), CS was low.

From the above, a glass produced at an annealing rate of 10° C. or higher and 150° C. or lower is preferred as a glass for chemical strengthening. In consideration of the crack initiation test, the annealing rate is preferably 15° C. or more and more preferably 20° C. or more. On the other hand, in consideration of CS, the annealing rate is preferably 130° C. or less and more preferably 100° C. or less.

While the present invention has been described in detail and with reference to specific embodiments thereof, it will be apparent to one skilled in the art that various changes and modifications can be made therein without departing from the spirit and scope of the present invention.

The present application is based on Japanese Patent Application (Application No. 2013-258116) filed on Dec. 13, 2013 and Japanese Patent Application (Application No. 2014-022850) filed on Feb. 7, 2014, and the entire thereof is incorporated herein by reference.

### INDUSTRIAL APPLICABILITY

The present invention is usable, for example, for cover glasses of small-size portable display devices, etc.

1. A chemically strengthened glass
comprising, as expressed by mass percentage based on oxides:
60% to 75% of SiO₂,
3% to 9% of Al₂O₃,
2% to 10% of MgO,
3% to 10% of CaO,
10% to 18% of Na₂O,
at most 4% of K₂O,
0% to 3% of ZrO₂,
0% to 0.3% of TiO₂, and
0.02% to 0.4% of SO₃;
having a temperature T₂ at which a viscosity of a glass melt is 100 dPa·sec of 1530° C. or lower; and
in a chemically strengthened main surface thereof, having a depth of a compressive stress layer of 8 μm or more and a surface compressive stress of 500 MPa or more.

2. The chemically strengthened glass according to claim 1, having a thickness falling within a range of 0.1 mm to 5 mm.

3. The chemically strengthened glass according to claim 1, chemically strengthened in all edge surfaces thereof.

4. The chemically strengthened glass according to claim 1, wherein the depth of the compressive stress layer is 25 μm or less.

5. The chemically strengthened glass according to claim 1, produced according to a float process.

6. The chemically strengthened glass according to claim 1, wherein an Sn component exists in at least one surface of glass surfaces.

7. A glass
comprising, as expressed by mass percentage based on oxides:
60% to 75% of SiO₂,
3% to 9% of Al₂O₃,
2% to 10% of MgO,
3% to 10% of CaO,
10% to 18% of Na₂O,
at most 4% of K₂O,
0% to 3% of ZrO₂,
0% to 0.3% of TiO₂, and
0.02% to 0.4% of SO₃; and
having a temperature T₂ at which a viscosity of a glass melt is 100 dPa·sec of 1530° C. or lower.

8. The glass according to claim 7, which is a glass applicable to a chemical strengthening treatment, having a depth of a compressive stress layer of 8 μm or more and a surface compressive stress of 500 MPa or more, in a chemically strengthened main surface thereof when being processed for the chemical strengthening treatment.

9. The glass according to claim 7, wherein when a refractive index at a room temperature of the glass is referred to as R₁ and when a refractive index at the room temperature of the glass, after kept at a temperature higher by about 100° C. than a glass transition point for 10 minutes and then annealed to the room temperature at a rate of 1° C./min, is referred to as R₂, R₂-R₁ is 0.0003 or more and 0.0012 or less.

10. The glass according to claim 7, produced according to a float process.

11. A glass for chemical strengthening
comprising, as expressed by mass percentage based on oxides:
60% to 75% of SiO₂,
3% to 9% of Al₂O₃,
2% to 10% of MgO,
3% to 10% of CaO,
10% to 18% of Na₂O,
at most 4% of K₂O,
0% to 3% of ZrO₂,
0% to 0.3% of TiO₂, and
0.02% to 0.4% of SO₃; and
having a temperature T₂ at which a viscosity of a glass melt is 100 dPa·sec of 1530° C. or lower.

12. The glass for chemical strengthening according to claim 11, wherein when a refractive index at a room temperature of the glass for chemical strengthening is referred to as R₁ and when a refractive index at the room temperature of the glass for chemical strengthening, after kept at a temperature higher by about 100° C. than a glass transition point for 10 minutes and then annealed to the room temperature at a rate of 1° C./min, is referred to as R₂, R₂-R₁ is 0.0003 or more and 0.0012 or less.

13. The glass for chemical strengthening according to claim 11, produced according to a float process.
